(19) United States
(12) Patent Application Publication
(10) Pub. No.: US 2004/0197079 A1
(43) Pub. Date: Oct. 7, 2004

(54) Method and a system for stateless load sharing for a server cluster in an IP-based telecommunications network

(75) Inventors: Mikael Latvala, Helsinki (FI); Petri Krohn, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/831,332

(22) Filed: Apr. 26, 2004

Related U.S. Application Data
(63) Continuation of application No. PCT/FI02/00745, filed on Sep. 19, 2002.

(30) Foreign Application Priority Data
Nov. 5, 2001 (FI) 20012137

(51) Int. Cl. H04N 5/76

(52) U.S. Cl. 386/46; 386/125

(57) ABSTRACT

The present invention concerns a method and a system for stateless load sharing for a server cluster in an IP based telecommunications network, comprising an IP based telecommunications network, a server cluster comprising server nodes for running an application process, and a load balancer for receiving packets and forwarding them to various server nodes. According to the invention the load balancer further comprises a distribution key obtainer for identifying and extracting at least one predetermined field from each dispatched packet or PDU contained within to be used as a distribution key, a hasher for hashing each distribution key to obtain an offset value for each packet, and a resolver for resolving a packet specific destination address for each packet using the obtained offset values.

### FIELD OF THE INVENTION

The present invention relates to telecommunications. In particular, the present invention relates to a novel and improved method and system for stateless load sharing for a server cluster in an IP based telecommunications network with high availability requirements.

### BACKGROUND OF THE INVENTION

A server cluster is a cluster of multiple server nodes across which server functionalities are distributed. Thus each functionality or application is divided into multiple parallel processes each running on different nodes.

In an IP (Internet Protocol, IP) based telecommunications network a server cluster typically has a single IP address identifying it to network elements utilizing its services. Internally, however, each node has at least one unique IP address. Using either a technique referred to as load sharing or a technique referred to as load balancing incoming IP traffic is distributed between the nodes. Load sharing refers to forwarding requests to server nodes. Load balancing refers to distributing requests to server nodes based on feedback from each node.

A typical server cluster comprises hundreds of nodes. New nodes may need to be added to the cluster, existing nodes may need to be removed or existing nodes may simply break down. A change in the cluster size will cause a reconfiguration or a reassignment of the nodes.

The IP traffic transmitted to a server cluster comprises sessions each of which comprises individual packets. All the packets of a session must be forwarded to the same server node. This can be achieved using either a stateful implementation or stateless implementation.

A stateful implementation of load sharing typically uses a stateful load balancer maintaining a session table which contains sessions served at one time. Using the session table the load balancer can forward subsequent IP packets belonging to a particular session to the same server node as the first packet of the session. An example of this approach is the ServerIron switch by Foundry Networks (http://www.foundrynet.com).

However, there are problems with stateful implementations. First of all, session awareness lowers the throughput of the load balancer. In practice, up to several million session entries are kept in the session table at one time. Thus memory requirements for a session table are significant which makes them difficult to implement. Also, a fault tolerant load balancer must checkpoint all the state information with another unit so that in case of switchover the other unit can assume the role of the failed unit without interruption. Thus, making a stateful load balancer fault tolerant means added complicity and increased signaling load. In addition, there is no way of knowing when a session ends. Usually a timer is used to clear sessions after 1-24 hours.

Stateless implementations of load sharing, such as broadcast based mechanisms for load sharing, do not use a load balancer. Instead they use a static algorithm to decide which server node to process. Typically the algorithm uses a hash function and hash bucket assignments. Examples of stateless implementations are Microsoft Windows NT Load Balancing Service and DHC Load Balancing Algorithm described in publication RFC3074 by IETF (Internet Engineering Task Force, IETF).

However, there are problems with present stateless implementations also. They rely on a broadcast mode of communication; incoming packets are received by all nodes in a cluster and each node separately checks whether it should serve the request. The main problem with current stateless implementations is that they require a great deal of processing power since every packet must be received by all nodes. Additionally, they are not designed for systems with high availability requirements. In order to provide carrier grade level service the system downtime must be extremely low, e.g. 0.001% or lower. In addition, systems must be able to undergo normal maintenance operations which should not result in a complete system-wide shutdown or reset. The present solutions do not provide this.

Thus, there is need for a load balancer providing both scalability and high availability for carrier grade level service.

### SUMMARY OF THE INVENTION

The present invention concerns a method and a system for stateless load sharing for a server cluster in an IP based telecommunications network. The system comprises an IP based telecommunications network for dispatching IP traffic comprising sessions comprising packets. Examples of sessions in the context of the present invention are TCP/IP connections (Transmission Control Protocol/Internet Protocol), SCTP-associations (Stream Control Transmission Protocol); and additionally higher level protocol sessions such as SIP (Session Initiation Protocol) sessions and VoIP (Voice over IP) calls. The system further comprises a server cluster comprising functionally identical server nodes for running an application process, each server node of which is assigned at least one unique IP address. The system further comprises one or more functionally identical, stateless load balancers for receiving the IP packets and forwarding them to various server nodes. Forwarding in this context comprises changing destination address including destination port number and modifying checksums accordingly. Forwarding can also include modification to fields of higher-level protocols e.g. changing Stream-ID in the case of SCTP. The load balancers are connected to the server cluster.

According to the invention the load balancers further comprise a distribution key obtainer for identifying and extracting at least one predetermined field from each dispatched packet or PDU (Protocol Data Unit, PDU) contained within to be used as a packet or PDU specific distribution key. Examples of such fields are Call-ID fields of SIP (Session Initiation Protocol) and Transaction-ID field of TCAP. TCAP refers to Transaction Capabilities Part and it is used in connection with SS7 (Signaling System 7). In a case where a PDU is distributed over several packets, said packets have the same distribution key.

The load balancers further comprise a hasher for hashing each distribution key to obtain an offset value for each IP packet. Thus the offset value is calculated using the formula:

offset=hash(key) mod M,

where key represents the distribution key, hash represents a hash function, M represents the number of hash bucket assignments and mod M represents modulus M of hash value.

The load balancers further comprise a resolver for resolving a packet specific destination address for each packet using the obtained offset values, said destination address comprising the IP address of the server node to which said packet is to be forwarded.

In an embodiment of the invention the load balancers further comprise an assignment table consisting of entries each comprising an IP address assigned to a server node, said table containing the IP address of each server node in one or more entries, and a retriever for retrieving the destination address for a packet from the assignment table by using the obtained offset value of the packet as an index. In an embodiment of the invention the number of entries in the assignment table is larger than the number of server nodes.

In an embodiment of the invention TCP (Transmission Control Protocol, TCP) protocol is used in IP traffic, and a connection tuple <IP_{S}, port_{S}, IP_{D}, port_{D}> as a whole or in part is used as the distribution key. IP_{S} represents the source IP address, port_{S} represents the source port number, IP_{D} represents the destination IP address and port_{D} represents the destination port number.

In an embodiment of the invention SCTP (Stream Control Transmission Protocol, SCTP) protocol is used in IP traffic, and an association <IP_{S}, ports, IP_{D}, port_{D}, protocol> as a whole or in part is used as the distribution key. IP_{S} represents the source IP address, ports represents the source port number, IP_{D} represents the destination IP address, port_{D} represents the destination port number and protocol represents the identifier of the higher-level protocol used.

In an embodiment of the invention a new node is added to the server cluster, and at least one entry in the assignment table is updated to contain the IP address of the added new node.

In an embodiment of the invention a node from the server cluster is removed, and each entry in the assignment table containing the IP address of the removed node is updated to contain the IP address of one of the remaining nodes.

In an embodiment of the invention the load balancers further comprise an adder for adding the obtained offset value of a packet to a base address assigned to the server cluster to obtain the destination address for the packet, which destination address is one of a range of IP addresses, of which range more than one address is assigned per each server node. Preferably said range of IP addresses is continuous. In an embodiment of the invention the number of addresses in the range of IP addresses is larger than the number of server nodes.

In an embodiment of the invention a new node is added to the server cluster, and at least one address of the range of IP addresses is reassigned to the added new node.

In an embodiment of the invention a node from the server cluster is removed, and the IP addresses of the removed node are reassigned to the remaining nodes.

In an embodiment of the invention at least one old server node is replaced with at least one new server node, each packet is analyzed to determine whether it initiates a session, packets initiating a session are forwarded to the new server node, and packets not initiating a session are forwarded to both the new server node and the old server node. Thus, this approach allows for graceful reassignment of a set of hash buckets from one server node to another. A packet initiating a session is sent only to the new node taking over. All other packets are sent both to the new and the old node or nodes. After a predetermined period of time it can be assumed that all sessions served by the old server node have ended and the old node can be taken off-line. In this approach the assignment table has at least two columns; one for new or current assignment and one or more for the old or outgoing assignment.

In an embodiment of the invention unicast IP addresses are used as the unique IP addresses assigned to each server node, at least one multicast IP address is bound to several server nodes, each packet is analyzed to determine whether it initiates a session, packets initiating a session are forwarded using the unicast address as the destination address, and packets not initiating a session are forwarded using the multicast address as the destination address. Thus this approach allows for graceful reassignment without any assignment table. Each bucket is assigned two IP addresses; a normal unicast address associated with one server node and an IP multicast address bound to several server nodes. The normal unicast address is bound to the incoming node and all packets initiating a session are forwarded with this address. Additionally each outgoing node is bound to one unicast address in the scope of the multicast address and all packets not initiating a session are forwarded with this address. Thus reconfiguration of server nodes causes no change in the load balancers. The bindings of the IP addresses to the server nodes are changed to direct traffic to correct nodes.

The present invention provides a load balancer with both scalability and high availability. Since each load balancer is identical, traffic can pass through any load balancer. If an anycast mechanism, such as IPv6 (Internet Protocol, Version 6) anycast addresses, is used, each individual packet can be routed through any load balancer. Since the number of hash buckets is larger than the number of server nodes, dynamic scaling and configuration of the server cluster is possible. In particular, the following three scenarios can be handled without having to reset: unexpected failure of a server node, controlled shutdown of a server node and addition of a new server node to a server cluster.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow chart illustrating a method according to one embodiment of the present invention.

FIG. 2 is a block diagram illustrating a system according to one embodiment of the present invention, and

FIG. 3 is a block diagram illustrating a system according to another embodiment of the present invention.

### DETAILED DESCRIPTION OF THE INVENTION

Reference will now be made in detail to the embodiments of the present invention, examples of which are illustrated in the accompanying drawings.

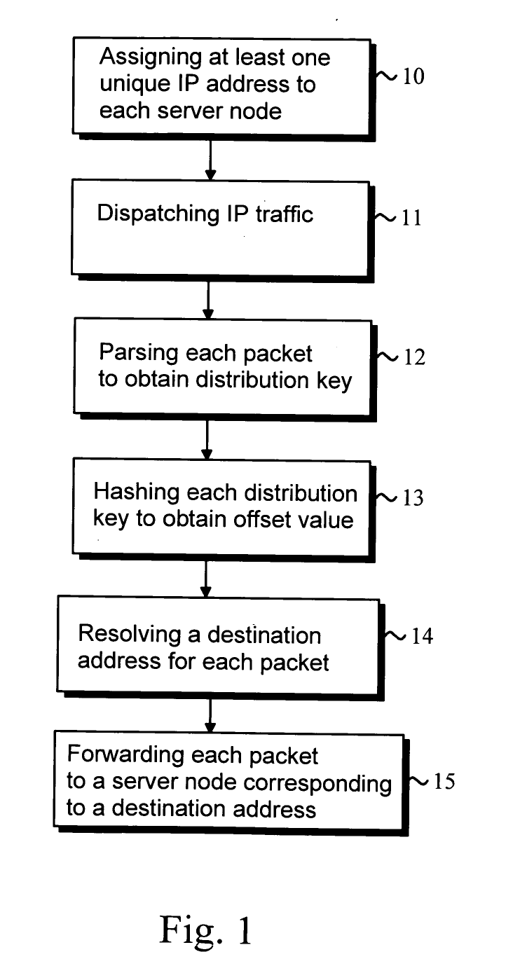

FIG. 1 illustrates a method for stateless load sharing for a server cluster in an IP based telecommunications network. At least one unique IP address is assigned to each server node of a server cluster, block 10. IP traffic comprising sessions comprising packets is dispatched, block 11. At least one predetermined field from each dispatched packet or PDU contained within is identified and extracted to be used as a packet specific distribution key, block 12. Each distribution key is hashed to obtain an offset value for each packet, block 13. A packet specific destination address is resolved for each packet using the obtained offset values, said destination address comprising the IP address of the server node to which said packet is to be forwarded, block 14. Each packet is forwarded to a server node corresponding to its resolved destination address, block 15.

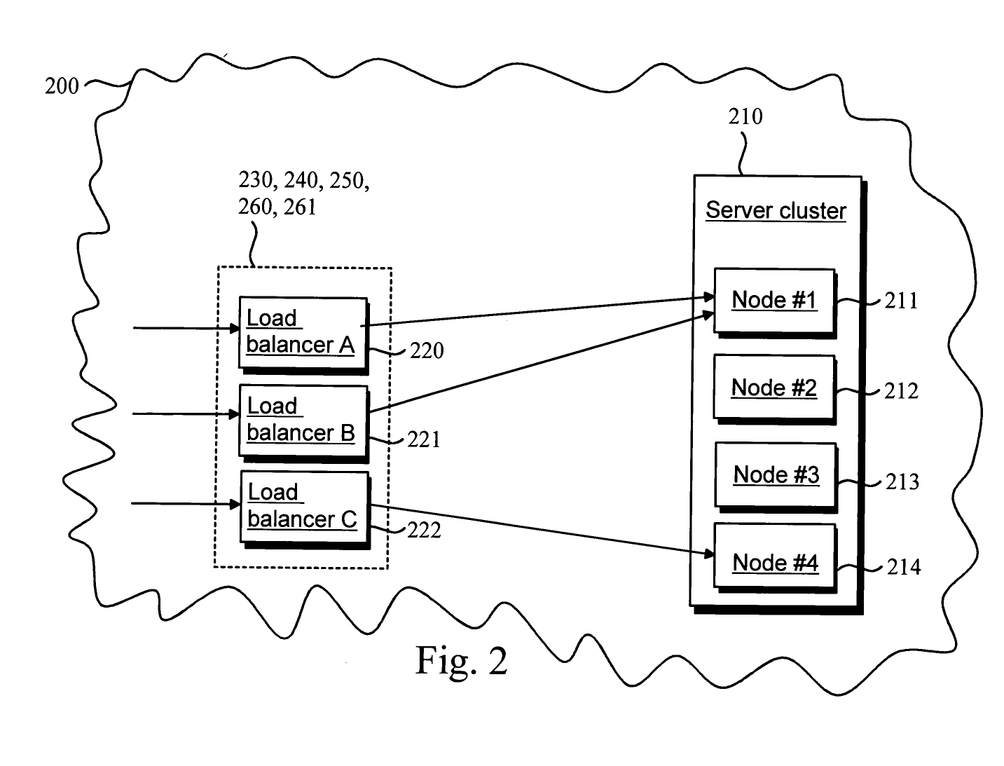

FIG. 2 illustrates a system for stateless load sharing for a server cluster in an IP based telecommunications network. The system comprises an IP based telecommunications network 200 for dispatching IP traffic comprising sessions comprising packets. The system further comprises a server cluster 210 comprising functionally identical server nodes 211, 212, 213 and 214 for running an application process, each server node of which is assigned at least one unique IP address. The system further comprises one or more functionally identical, stateless load balancers 220, 221 and 222 for receiving the packets and forwarding them to various server nodes. The load balancers 220, 221 and 222 are connected to the server cluster 210.

The load balancers 220, 221 and 222 further comprise a distribution key obtainer 230 for identifying and extracting at least one predetermined field from each dispatched packet or PDU contained within to be used as a packet specific distribution key. The load balancers 220, 221 and 222 further comprise a hasher 240 for hashing each distribution key to obtain an offset value for each packet. The load balancers 220, 221 and 222 further comprise a resolver 250 for resolving a packet specific destination address for each packet using the obtained offset values, said destination address comprising the IP address of the server node to which said packet is to be forwarded. In one embodiment of the invention TCP protocol is used in IP traffic, and a connection tuple <IP_{S}, port_{S}, IP_{D}, port_{D}> as a whole or in part is used as the distribution key. In another embodiment of the invention SCTP protocol is used in IP traffic, and an association <IP_{S}, port_{S}, IP_{D}, port_{D}, protocol> as a whole or in part is used as the distribution key.

The load balancers 220, 221 and 222 further comprise an assignment table 260 consisting of entries each comprising an IP address assigned to a server node, said table containing the IP address of each server node in one or more entries. The load balancers 220, 221 and 222 further comprise a retriever 261 for retrieving the destination address for a packet from the assignment table 260 by using the obtained offset value of the packet as an index. The number of entries in the assignment table 260 is larger than the number of server nodes.

If a new node is added to the server cluster, at least one entry in the assignment table 260 is updated to contain the IP address of the added new node. If a node from the server cluster 210 is removed, each entry in the assignment table 260 containing the IP address of the removed node is updated to contain the IP address of one of the remaining nodes.

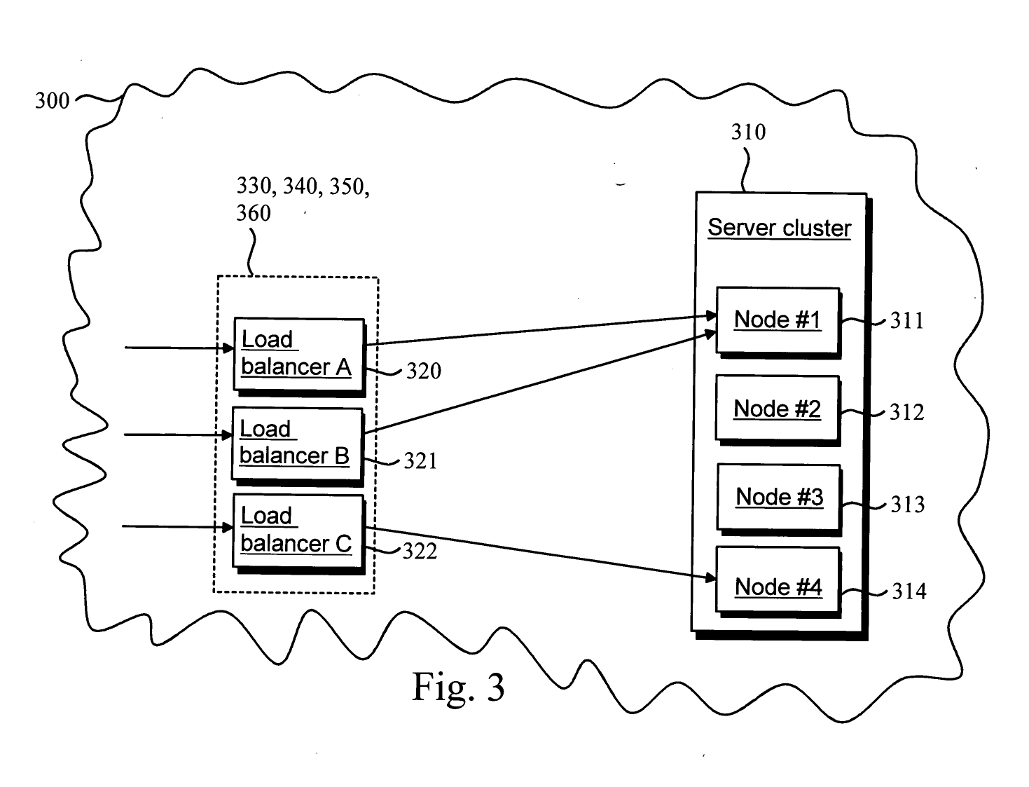

FIG. 3 illustrates a system for stateless load sharing for a server cluster in an IP based telecommunications network. The system comprises an IP based telecommunications network 300 for dispatching IP traffic comprising sessions comprising packets. The system further comprises a server cluster 310 comprising functionally identical server nodes 311, 312, 313 and 314 for running an application process, each server node of which is assigned at least one unique IP address. The system further comprises one or more functionally identical, stateless load balancers 320, 321 and 322 for receiving the packets and forwarding them to various server nodes. The load balancers 320, 321 and 322 are connected to the server cluster 310.

The load balancers 320, 321 and 322 further comprise a distribution key obtainer 330 for identifying and extracting at least one predetermined field from each dispatched packet or PDU contained within to be used as a packet specific distribution key. The load balancers 320, 321 and 322 further comprise a hasher 340 for hashing each distribution key to obtain an offset value for each packet. The load balancers 320, 321 and 322 further comprise a resolver 350 for resolving a packet specific destination address for each packet using the obtained offset values, said destination address comprising the IP address of the server node to which said packet is to be forwarded.

The load balancers 320, 321 and 322 further comprise an adder 360 for adding the obtained offset value of a packet to a base address assigned to the server cluster 310 to obtain the destination address for the packet, which destination address is one of a range of IP addresses, of which range more than one address is assigned per each server node. The number of addresses in the range of IP addresses is larger than the number of server nodes.

If a new node is added to the server cluster, at least one address of the range of IP addresses is reassigned to the added new node. If a node from the server cluster is removed, the IP addresses of the removed node are reassigned to the remaining nodes.

It is obvious to a person skilled in the art that with the advancement of technology, the basic idea of the invention may be implemented in various ways. The invention and its embodiments are thus not limited to the examples described above, instead they may vary within the scope of the claims.

1. A method for stateless load sharing for a server cluster in an IP based telecommunications network, comprising the steps of:
assigning at least one unique IP address to each server node of a server cluster, and
dispatching IP traffic comprising sessions comprising packets,
characterized in, that the method further comprises the steps of:
identifying and extracting at least one predetermined field from each dispatched packet or PDU contained within to be used as a distribution key,
hashing each distribution key to obtain an offset value for each packet,
resolving a packet specific destination address for each packet using the obtained offset values, said destination address comprising the IP address of the server node to which said packet is to be forwarded, and
forwarding each packet to a server node corresponding to its resolved destination address.

2. The method according to claim 1, characterized in that the method further comprises the steps of:
generating an assignment table consisting of entries each comprising an IP address assigned to a server node, said table containing the IP address of each server node in one or more entries, and
using the obtained offset value of a packet as an index with which to retrieve the destination address for the packet from the generated assignment table.

3. The method according to claim 2, characterized in that the number of entries in the assignment table is larger than the number of server nodes.

4. The method according to claim 2, characterized in that the method further comprises the steps of:
using TCP protocol in IP traffic, and
using a connection tuple <IP_{S}, port_{S}, IP_{D}, port_{D}> as a whole or in part as the distribution key.

5. The method according to claim 2, characterized in that the method further comprises the steps of:
using SCTP protocol in IP traffic, and
using an association <IP_{S}, port_{S}, IP_{D}, port_{D}, protocol> as a whole or in part as the distribution key.

6. The method according to claim 2, characterized in that the method further comprises the steps of:
adding a new node to the server cluster, and
updating at least one entry in the assignment table to contain the IP address of the added new node.

7. The method according to claim 2, characterized in that the method further comprises the steps of:
removing a node from the server cluster, and
updating each entry in the assignment table containing the IP address of the removed node to contain the IP address of one of the remaining nodes.

8. The method according to claim 1, characterized in that the method further comprises the steps of:
using a range of IP addresses while assigning addresses to the server nodes, of which range one or more addresses are assigned per each server node,
assigning a base address to the server cluster, and
combining the obtained offset value of a packet and the assigned base address to obtain the destination address for the packet.

9. The method according to claim 8, characterized in that the number of addresses in the range of IP addresses is larger than the number of server nodes.

10. The method according to claim 8, characterized in that the method further comprises the steps of:
adding a new node to the server cluster, and
reassigning at least one address of the range of IP addresses to the added new node.

11. The method according to claim 8, characterized in that the method further comprises the steps of:
removing a node from the server cluster, and
reassigning the IP addresses of the removed node to the remaining nodes.

12. The method according to claim 1, characterized in that the method further comprises the steps of:
replacing at least one old server node with at least one new server node,
analyzing each packet to determine whether it initiates a session,
forwarding packets initiating a session to the new server node, and
forwarding packets not initiating a session to both the new server node and the old server node.

13. The method according to claim 1, characterized in that the method further comprises the steps of:
using unicast IP addresses as the unique IP addresses assigned to each server node,
binding at least one multicast IP address to several server nodes,
analyzing each packet to determine whether it initiates a session,
forwarding packets initiating a session using the unicast address as the destination address, and
forwarding packets not initiating a session using the multicast address as the destination address.

14. A system for stateless load sharing for a server cluster in an IP based telecommunications network, comprising:
an IP based telecommunications network (200) for dispatching IP traffic comprising sessions comprising packets,
a server cluster (210) comprising functionally identical server nodes (211, 212, . . . , N) for running an application process, each server node of which is assigned at least one unique IP address, and
one or more functionally identical, stateless load balancers (220, 221, . . . , N) for receiving the packets and forwarding them to various server nodes, which load balancers are connected to the server cluster,
characterized in, that the load balancers further comprise:
a distribution key obtainer (230) for identifying and extracting at least one predetermined field from each dispatched packet or PDU contained within to be used as a distribution key,
a hasher (240) for hashing each distribution key to obtain an offset value for each packet, and
a resolver (250) for resolving a packet specific destination address for each packet using the obtained offset values, said destination address comprising the IP address of the server node to which said packet is to be forwarded.

15. The system according to claim 14, characterized in that the load balancers further comprise:
an assignment table (260) consisting of entries each comprising an IP address assigned to a server node, said table containing the IP address of each server node in one or more entries, and
a retriever (261) for retrieving the destination address for a packet from the assignment table by using the obtained offset value of the packet as an index.

16. The system according to claim 15, characterized in that the number of entries in the assignment table is larger than the number of server nodes.

17. The system according to claim 14, characterized in that the load balancers further comprise:
an adder (360) for combining the obtained offset value of a packet to a base address assigned to the server cluster to obtain the destination address for the packet, which destination address is one of a range of IP addresses, of which range one or more addresses are assigned per each server node.

18. The system according to claim 17, characterized in that the number of addresses in the range of IP addresses is larger than the number of server nodes.
